(19) United States
(12) Patent Application Publication
(10) Pub. No.: US 2007/0188451 A1
(43) Pub. Date: Aug. 16, 2007

(54) MOUSE HAVING MASSAGE FUNCTION

(75) Inventor: ZHENG-HENG SUN, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,716

(22) Filed: Sep. 15, 2006

(30) Foreign Application Priority Data
Feb. 11, 2006 (CN) 200610033600.3

(51) Int. Cl. G09G 5/08

(52) U.S. Cl. 345/163

(57) ABSTRACT

A mouse having a massage function, the mouse includes a shell, a cable connected to a host computer, and a vibration device mounted in the shell. The vibration device includes a vibrator and a switch. The cable is connected to the vibrator via the switch, and transmits power from the host computer to the vibrator.

### FIELD OF THE INVENTION

The invention relates to an input device for use in a computer system. In particular, the present invention relates to a mouse having a massage function.

### DESCRIPTION OF RELATED ART

The internal components in computer mouse are very simple. In view of the space required for these components, the volume of available space remaining in the mouse is comparatively great. That is because the size of the housing of the mouse is designed for being conveniently and comfortably grasped by a user, and thus most of the inside space of the mouse is vacant.

A conventional mouse includes a shell, two buttons, and optionally a scroll wheel. The shell includes an upper portion and a lower portion. The buttons and the scroll wheel are disposed at the front part of the upper portion for finger pressing, and a rear part of the upper portion is in a raised shape for comfortable contact with a palm of the user.

The user typically holds the mouse and moves it on a supporting surface, and it is common that the users' arm and hand will become fatigued after prolonged use of the mouse.

What is needed is a mouse having a massage function.

### SUMMARY OF THE INVENTION

An exemplary mouse having a massage function is provided. The mouse includes a shell, a cable connected to a host computer, and a vibration device mounted in the shell. The vibration device includes a vibrator and a switch. The cable is connected to the vibrator via the switch, and transmits power from the host computer to the vibrator.

Other advantages and novel features will become more apparent from the following detailed description when taken in conjunction with the accompanying drawing, in which:

### BRIEF DESCRIPTION OF THE DRAWINGS

FIG. 1 is an isometric view of a mouse in accordance with a preferred embodiment of the present invention;

FIG. 2 is a top view of FIG. 1;

FIG. 3 is a partly cut away side view of FIG. 1; and

FIG. 4 is a schematic circuit diagram of the mouse of FIG. 1.

### DETAILED DESCRIPTION OF THE INVENTION

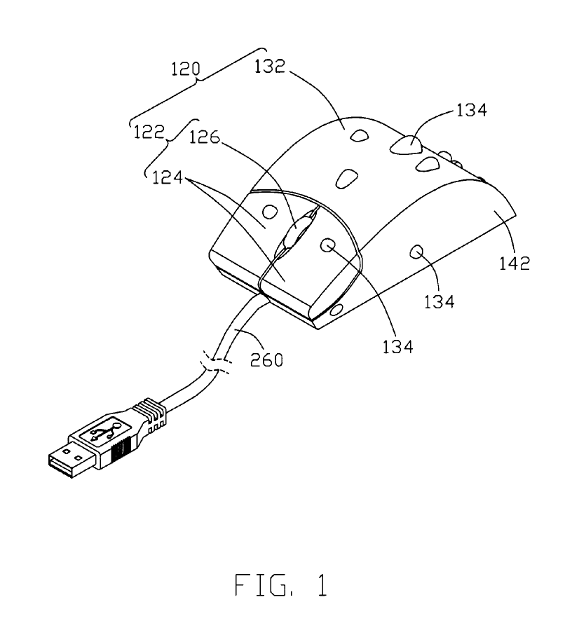

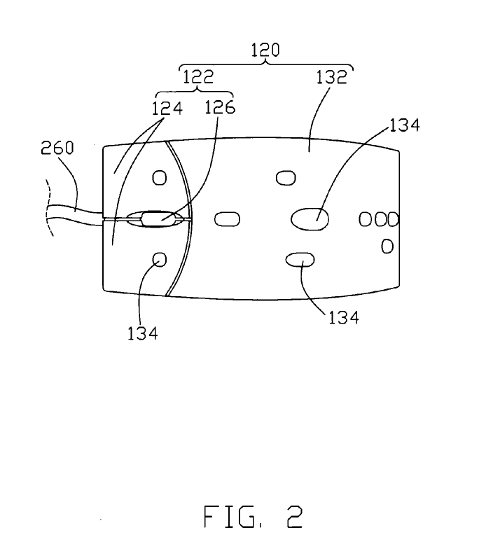

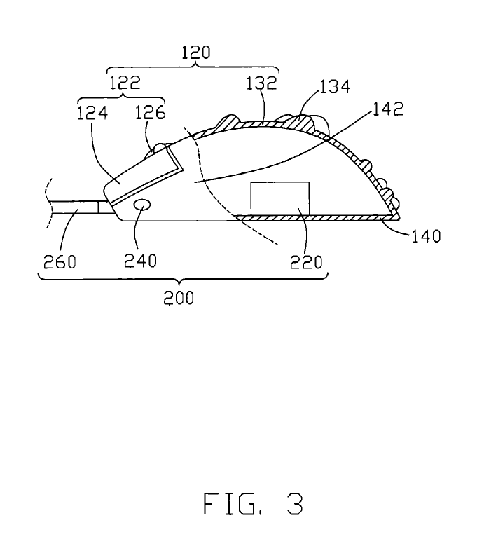

Referring to FIGS. 1 to 3, the mouse includes a shell and a vibration device 200 mounted in the shell.

The shell includes an upper portion 120 and a lower portion 140. A front part of the upper portion 120 is used as a finger operating portion 122 that includes two buttons 124 and a scroll wheel 126. The buttons 124 and the scroll wheel 126 are configured for finger pressing. A rear part of the upper portion 120 has a raised palm holding portion 132. The lower portion 140 includes a sidewall 142, which is connected with the upper portion 120. A plurality of protruding portions 134 is mounted on the upper portion 120 and the sidewall 142.

The vibration device 200 includes a vibrator 220 and a switch 240. The switch 240 is placed on the sidewall 142 of the lower portion 140. The vibrator 220 is mounted in the lower portion 140 under the palm holding portion 132 of the upper portion 120. The switch 240 is used to turn on or off the vibrator 220. A cable 260 extends out of the shell to connect with a computer. In the preferred embodiment of the present invention the cable 260 is a universal serial bus (USB) cable. The cable 260 is used to transmit signals of the buttons 124 and the scroll wheel 126 to the computer and transmit power from the computer to the vibrator 220.

The vibrator 220 starts vibrating when the switch 240 is turned on, then the buttons 124 and the scroll wheel 126 are disable to prevent accidental input of the buttons 124 and the scroll wheel 126 when the vibrator 220 is vibrating and requiring a user to take a real break from operating the computer. The protruding portions 134 arranged on the shell also vibrate with the vibrator 220, thus providing point massage of a user's hand.

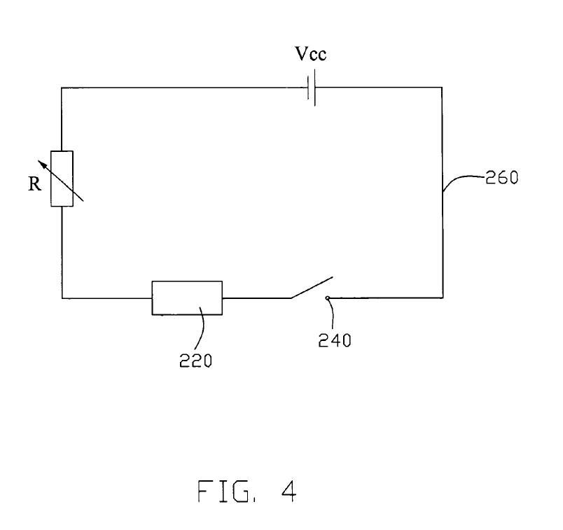

Referring also to FIG. 4, the vibrator 220, the switch 240, and the cable 260 are connected in series. The cable 260 is connected to a USB power source Vcc that provides operating power to the vibrator 220. A rheostat R is connected in series with the vibrator 220, and the scroll wheel 126 is connected to an adjusting bar of the rheostat R. Scrolling the scroll wheel 126 can move the adjusting bar of the rheostat R. A voltage of the vibrator 220 is changed as a resistance of the rheostat R is adjusted by scrolling the scroll wheel 126, which adjusts vibration amplitude of the vibrator 220, thus providing an adjustable hand held massager.

In this embodiment, the vibrator 220 can be automatically switched on or off by a software. For example, the software sends out a signal to the vibrator 220 to open the vibrator 220 after the mouse has been in use for two hours, then the buttons 124 and the scroll wheel 126 are cut off from the computer. The signal sent out from the software is transmitted to the vibrator 220 via the cable 260.

The mouse in accordance with the preferred embodiments of the present invention can increase comfort to the user, and lessen the user's fatigue. Further, used as a hand held massager, relief for other body parts can be achieved.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments.

What is claimed is:

1. A mouse having a massage function, the mouse comprising a shell, a cable configured so as to be connected to a host computer, and a vibration device mounted in the shell, the vibration device comprising a vibrator and a switch, the cable connected to the vibrator via the switch, and transmitting power from the host computer to the vibrator.

2. The mouse as claimed in claim 1, wherein the shell includes an upper portion and a lower portion, a front part of the upper portion has a finger operating portion, a rear part of the upper portion has a palm holding portion.

3. The mouse as claimed in claim 2, wherein the finger operating portion includes two buttons and a scroll wheel configured for finger pressing, the palm holding portion has a raised shape configured for contacting a palm of a user.

4. The mouse as claimed in claim 3 wherein the lower portion includes a sidewall connected with the upper portion, a plurality of protruding portions is arranged on the upper portion and the sidewall of the lower portion.

5. The mouse as claimed in claim 4, wherein when the switch is turned on to start up the vibrator the buttons and the scroll wheel are cut off from the host computer, a rheostat is connected to the vibrator in series, and the scroll wheel is connected to an adjusting bar of the rheostat, vibration amplitude of the vibrator is adjusted by operating the scroll wheel.

6. A mouse having a massage function, the mouse comprising a shell having a scroll wheel, and a vibration device mounted in the shell, the vibration device comprising a vibrator and a switch, a cable being connected to the vibrator via the switch, a rheostat being connected to the vibrator in series, and the scroll wheel being connected to an adjusting bar of the rheostat, and vibration amplitude of the vibration device being adjusted by operating the scroll wheel.

7. The mouse as claimed in claim 6, wherein the cable extends out of the shell to connect to a host computer to transmit power from the host computer to the vibrator, and transmit data from the mouse to the host computer.

8. The mouse as claimed in claim 7, wherein the shell includes an upper portion and a lower portion, a front part of the upper portion is a finger operating portion, a rear part of the upper portion is a palm holding portion.

9. The mouse as claimed in claim 8, wherein the finger operating portion includes two buttons and the scroll wheel configured for finger pressing, the palm holding portion has a raised shape configured for contacting a palm of a user.

10. The mouse as claimed in claim 9, wherein the lower portion includes a sidewall connected with the upper portion, a plurality of protruding portions is arranged on the upper portion and the sidewall of the lower portion.

11. The mouse as claimed in claim 10, wherein when the switch is turned on to start up the vibrator the buttons and the scroll wheel are cut off from the host computer.

12. A mouse having a massage function, comprising:
a shell having a finger operation portion, the finger operation portion being operable to produce a signal for controlling a computer;
a vibrator mounted in the shell, the vibrator being configured for vibrating the shell when activated; and
a plurality of protrusions fixedly mounted on an outer peripheral surface of the shell.

13. The mouse of claim 12, wherein each of the protrusions is sized to provide point massage when vibrating with the vibrator.
